(19) United States
(12) Patent Application Publication
(10) Pub. No.: US 2016/0371971 A1
(43) Pub. Date: Dec. 22, 2016

(54) Process and Schematic for Operating Electronic Devices By Remote Control and for Collecting, Utilising, and Transmitting the Operating Parameters of Such Devices for the Purposes of Analysis

(71) Applicants: Lenard Zoltan Pasztor, Dregelypalank (HU); Tamas Fabian, Budapest (HU); Andras Barath, Budapest (HU)

(72) Inventors: Lenard Zoltan Pasztor, Dregelypalank (HU); Tamas Fabian, Budapest (HU); Andras Barath, Budapest (HU)

(21) Appl. No.: 15/121,442

(22) PCT Filed: Feb. 24, 2015
(86) PCT No.: PCT/HU2015/000019

§ 371 Date: Aug. 25, 2016

(30) Foreign Application Priority Data
Feb. 25, 2014 (HU) P14000499
Oct. 21, 2014 (HU) P1400499

(51) Int. Cl. G08C 17/02; H04N 5/44

(52) U.S. Cl. CPC G08C 17/02; H04N 5/4403; G08C 2201/92; G08C 2201/93; G08C 2201/20

(57) ABSTRACT

The invention is a process and a system for the operation of electronic devices by universal remote control and for collecting, utilising and transmitting the operating parameters of such devices for the purposes of analysis. The administrator:—downloads the application from an external server to his mobile device;—registers on the external server, creates his profile;—logs in;—selects the devices he wishes to control from a list of controllable devices automatically detected by the application which automatically downloads the corresponding user interfaces to control the selected devices and assigns the selected devices to the administrator's profile;—defines which pieces of information pertaining to the controlled devices should be sent to the analytical module for storage and analysis, and which should be accessible to third parties via Internet; and uses his profile to create subprofiles for other users that grant the authorisations necessary to control the devices he designates.

The subject of this invention is a process and schematic for the operation of electronic devices by universal remote control and for collecting, utilising and transmitting the operating parameters of such devices for the purposes of analysis. The invention permits the operation of any suitable electronic apparatus using any device usable as a remote control, including universal remote controls in physically isolated form and other portable devices that can be equipped with remote control functionality (smart phones, tablets, notebook computers, and PCs). The invention makes it possible for an authorised person to assign different user access rights or user interfaces to different users with regard to a single device, or to several devices within the same household, and to make operating information on controlled devices accessible to third parties via an external network. Protection against external infiltration is ensured via encrypted communication channels.

The invention may be used to advantage for the control of household devices, entertainment electronics, and electronically controlled toys, as well as in the field of building automation. The transmission to third parties of the operating parameters associated with individual electronic devices may serve as the basis for repair services or may offer assistance to manufacturers in the area of product design and/or the improvement of technical parameters on existing products.

Solutions most similar to that of this invention may be grouped into two basic categories:
1. universal remote control solutions;
2. solutions that permit remote access by external servers/third parties to information pertaining to the operation of electronic household equipment via Internet.

The universal remote control solutions currently in widespread use and their shortcomings can be described as follows:

a) Remote control devices operating on the conventional principles of infrared and radio-frequency signal transmission generally connect to only one apparatus. Not even the universal remote controls appearing in physically isolated form that developed from these devices can be used with all other devices and applications. Furthermore, such solutions do not employ authentication mechanisms that use encrypted channels for the purpose of authorising servers.

b) Universal remote control applications that can be downloaded onto portable devices (mobile/cellular telephones, tablets) that are either capable of handling WiFi or are adapted to other forms of wireless, microwave communication (e.g. Kijit, iRule, RedEye, Re, Zmart), which permit control of such devices as the applications support. These applications, too, communicate across channels that are not encrypted, nor can they identify the user; thus, anyone in possession of the mobile device can access its control functionality.

c) Universal remote control solutions appearing simultaneously in the form of hardware and software (e.g. Logitech Harmony), which typically consist of a hub, a universal remote control device, and a mobile apparatus or software that can be installed on a personal computer, and which are able to access external databases either indirectly or directly via the Internet. The deficiency in these solution is that they do not verify user identity, their control interfaces generally cannot be moved from one mobile device to another, and they do not offer analytical functionality.

d) Closed networks generally developed by a single manufacturer primarily to promote the control and cooperation of all devices the manufacturer produces. Currently only a few multinational companies (such as Samsung—Samsung Home Network) offer such a complex system. Universal control options of this type are usually restricted to the devices distributed by a particular company.

Of the above, from the standpoint of the structural attributes and functionality of the present invention, prior art is represented by solutions of types b) and c). With regard to applications falling into category b), it should be noted that they are often free and do not enjoy patent protection.

Patent specification U.S.2013147612 describes a universal remote controller and remote control method. The remote controller includes a display screen, a communication module configured to communicate with a plurality of devices, an input unit configured to receive a user command, a controlling unit configured to receive identification information from a device of the plurality of devices which is pointed at by the remote controller and through the communication module, control the display screen to display a user interface customized for the device corresponding to the identification information, and receive information input through the user interface for communication with the device so that the remote controller can operate with the device.

Patent specification U.S.2003141987 describes a solution that includes controlled device(s), a remote control (that can be any application or portable device), a computer/gateway that enables connection with an external network (Wide Area Network—WAN) and that operates as a local data storage unit/database, a local database reachable through an internal network (Local Area Network—LAN), an external database reachable via WAN, and a data storage unit readable by electronic devices that stores the commands used to control the system (readable media). Once the device to be controlled has been identified, the remote control downloads the control code belonging to the device to be controlled and/or the graphic interface primarily from the local database via LAN, or secondarily from a database on an external server by means of a personal computer or other gateway via WAN, then stores it/them on the remote control, which, once properly configured, becomes capable of fulfilling the remote control function. The data used to achieve this functionality may be stored on both the remote control and the personal computer. The readable media may store commands that the system executes accordingly.

The common features of these solutions is that the scope of universality is not clearly defined, that they do not possess an analytical module for the purpose of collecting and analysing data on both user habits and the controlled devices, and that at most, they offer a solution to the problem of security from the perspective of the devices, but not that of the user. With such devices, authentication at the system, rather than the device level, via LAN or WAN is not possible, and neither, therefore, can authentications pertaining to the control of various devices be stored on a user-by-user basis.

Of various inventions that enable external servers/third parties to remotely access, via Internet, information pertaining to the operation of electronic household appliances, we consider patent specification U.S.2012019378 worthy of inclusion here. This specification describes a method and system for monitoring an appliance consisting of an electronic device, a connected communications module, a short-range communications network, the Internet as a long-range communications network, and an external service centre that is capable of receiving transmissions in uninterrupted fashion. The communications module is connected directly to the short-range communications network, which enables the transmission of data via Internet, which the service centre receives. Data pertaining to the operation of the electronic device is collected by the communications module, which transmits them to the service centre. The analysis of this data occurs primarily at the service centre, though provisions are made for the communications module to perform analytical functions and to compare incoming data to pre-set limit values and to send the data on to the service centre only where improper operation is detected.

From the above it may be established that the system does not include a mobile user device across which data is transmitted, nor does the method enable any restriction of data traffic. Furthermore, local data analysis does not occur in an analytical module that is independent of the communications module.

In contrast to the above, the objective of this invention was to develop a solution that:
Is universal in the broadest possible sense; that is, that can control as many devices as possible;
Differentiates between administrators and simple users;
Is capable of transmitting information on the operation of individual devices in a pre-analyses form to the extent desired by an administrator;
Is capable of identifying a plurality of individual users (administrators) and to handle user access rights on a user-by-user basis;
Does not link user access rights and associated data, along with the information required for controlling devices, to the devices themselves, but rather permits them to be downloaded to any device;
Is secure against external, unauthorised infiltration;
Offers a ready-to-use solution that can be installed simply, on the basis of included documentation

The vast majority of mobile devices used today possess communications capabilities (Bluetooth, Wi-Fi) that render them adaptable to both remote control and Internet access. On the other hand, while household devices have also undergone revolutionary change in terms of communications technology, progress has not resulted in any improvement in the quality of their use at the system level, nor in the ability to track their operation in a manner that provides practical information essential from the standpoint of service and design, nor has it enabled any real distribution of user access rights to the devices in question.

In developing this invention, the key realisation was that by combining the seemingly very different fields of remote control via mobile device and the provision of diagnostic information, a solution package may be offered that offers distinct advantages to both the user and the manufacturer.

The key idea embodied by this invention is that the authentication of users should be approached not from the standpoint of devices and remote controls, but from that of the users, so that access rights are linked not to individual devices, but directly to administrators(s)/user(s) through pre-created (sub)profiles.

This patent specification shall define the following terms as given below:

Administrator: the individual who, with regard to a specific electronic device, first registers the device on the external server after the application has been downloaded.

User: an individual who is granted remote control access rights for a given electronic device only to the extent permitted by the administrator.

(Administrator) Profile: a set of data that includes all information related to the devices to be controlled as assigned to and by the administrator, which the administrator creates in the external server database following registration, and which features a user interface adapted to the control functionality.

(User) Subprofile: a set of data created by the administrator in the external server database, within his/her own profile, following his/her own registration, such as includes all information pertaining to the control access rights and restrictions assigned to the user, and which features a user interface adapted to the control functionality.

The schematic according to this invention is described below by means of diagrams.

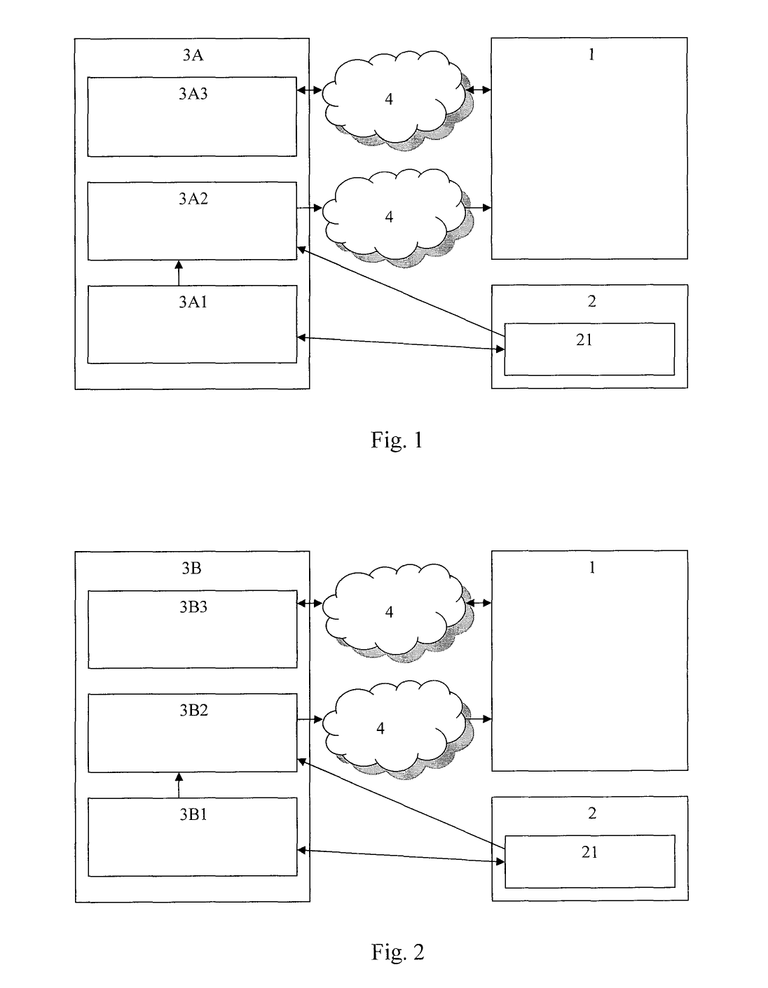

FIG. 1 shows a schematic for the universal remote control device (3A) used by an administrator,

FIG. 2 shows a schematic for the universal remote control device used by a normal user.

FIG. 1 clearly shows that the universal remote control device (3A) has three modules. The authentication module (3A3) connects to the external server (1) via an external network (4), while the control module (3A1) has a bidirectional connection with the controlled module (21) to be installed in the controlled device (2) and a unidirectional connection with and in the direction of the analytical module (3A2). The connection between the control module (3A1) and the analytical module (3A2) is unidirectional in the direction of the analytical module (3A2). The analytical module (3A2) is connected to the database installed on the external server (1) via the external network (4).

The universal remote control device (3A) can be any mobile device theoretically capable of remote control functionality on which the software necessary for implementing remote control functionality can be run.

The authentication module (3A3) serves to monitor all authorisations pertaining to user authentication and device management.

The controlled module (21) is a microchip built into the controlled device (2) either during manufacture, or at a later time, which renders said device capable of bidirectional communication with the universal remote control device.

The analytical module (3A2) is used to store the status signals arriving from the controlled module (21), measured values and related statistics pertaining to the controlled device (2), and information related to user habits and activities.

The database installed on the external server (1) is used to store information on (the) administrator profile(s) and user subprofile(s), as well as graphic elements to be displayed as a user interface on the universal remote control device and any logical elements to be run on the same.

FIG. 2 shows the schematic of the user universal remote control device (3B) according to this invention, which essentially consists of the same units and the administrator universal remote control device (3A). As many of both the administrator, and user universal remote control devices (3A, 3B) may be used as is desired for the application in question.

Complete implementation of the invention does not require that the universal remote control devices (3A, 3B) bet physically different; the universal remote control device (3B) may serve as another household universal remote control device, as well.

Operation of the invention is described below:

First, the administrator downloads the application from an external server via the external network to his/her own mobile device, then registers on the external server, creates his/her own profile, and logs in. The administrator then selects the devices he/she wishes to control from a list of controllable devices automatically detected by the application. Subsequently, the application automatically downloads the user interfaces corresponding to the selected devices from the external server to the administrator's mobile device and in doing so, renders the selected devices remotely controllable from his/her mobile device, while at the same time assigning the selected devices to the administrator's profile. Thus, the administrator, using the application, can define which pieces of information pertaining to the controlled devices should be sent to the analytical module for storage and analysis, and which should be accessible to third parties via the Internet. From that time on, the administrator can use his/her profile to create subprofiles for other users that grant the authorisations necessary to control the devices he/she designates.

Below, implementation of the invention is illustrated by means of two separate examples:

### EXAMPLE 1

### Authorisation for the Transmission of Diagnostic Information on a Washing Machine

In this case, we assume that our invention has been sold to a washing machine manufacturer.

The manufacturer first builds the microchip that enables it to assume the functionality or the controlled module of the invention into the washing machine, then uploads the washing machine's unique identifier to the database on the external server. At the time or after the washing machine is purchased, the manufacture informs the buyer that if, for example,

he/she would like to control the washing machine using his/her mobile phone as a remote control device, or
would like to learn more about the functionality of the washing machine, or
would like to obtain an expanded guarantee and direct contact with the manufacture,
he/she may download the washing machine application from the external server to his/her mobile telephone and authorise the transmission of diagnostic information on the machine to the manufacturer.

If the buyer decides to install the application, our invention can be made suitable for use in the following way:

Once the buyer has downloaded the washing machine application to his/her telephone, the application (or a Web browser) can be used to register in the manufacturer's database and create a profile, if the buyer has not done so before, using some other mobile device. In performing this step, the buyer logs into the application, after which the application detects that there is a washing machine in its environment. The buyer inputs this machine into his/her profile, thus becoming the administrator for that machine.

Subsequently, the application, using the unique identifier, checks whether the manufacturer really produced the machine and whether anyone else has registered as the device's administrator. If there is no reason not to, the washing machine is registered and the application downloads the remote control(s) corresponding to that machine from the database on the external server. In doing this, the administrator makes it possible for the manufacturer to access the washing machine's diagnostic information.

The end result of the installation, registration, and implementation process is that the manufacturer knows precisely which of its finished washing machines has been purchased by the buyer (administrator), and receives continuous information on the operation of that machine. The resulting database aids the manufacturer both in the course of future product design, and as regards the organisation of repair and maintenance services.

In the meantime, the administrator can control the machine using the application installed on his/her mobile telephone and may grant other users the authorisation to do the same (see example 2).

### EXAMPLE 2

### The Distribution of Remote Control Access Rights

In this case, the process of downloading and implementing the application is analogous to that described in the previous example; however, the control of household appliances is not restricted to the administrator alone. For a more interesting case from real life, we offer the example of how a television set can be controlled:

Assume that the administrator of a television set lives in a single household with two other people.

First the administrator sets the television so that it can be controlled only from his/her mobile application, instead of from the remote control that came with it.

Then, using the application, he creates two subprofiles with different content within his/her own:
1. Content of first profile:
Access to channels A, B and C, but not to any others
All TV-watching time is restricted to an interval of T
Access to the set's HDMI input in authorised
2. Content of second profile:
Authorisation for full use of the television set
Specially designed remote control user interface.

Once users 1 and 2 have downloaded the application to their mobile telephones, gain access to and control over the television set according to the content of their individual subprofiles.

From that point forward, the administrator and users can each use the application to create their own, custom remote control, while upholding the required authorisation levels.

It will also be possible to input control commands using the actual buttons and screens on the universal remote control devices, or by changing the orientation of the universal remote control device.

The external network does not have to be continuously available in order for the invention to work: once the user has been authenticated and the appropriate information packages for creating the user interface corresponding to the device have been downloaded from the proper database, the remote control functions can be used fully even in the absence of a network connection. In the event of an interruption in or suspension of the connection to the external network, the analytical module stores diagnostic information pertaining to the controlled devices for transmission to third parties at a later time.

The advantages afforded by this solution can be summarised as follows:
It simplifies the remote control of electronic devices and renders the process more secure;
It provides access control on a user-by-user basis and enables the configuration of custom user interfaces and functions,
It frees the user from purchasing a new universal remote control for each new electronic device, reducing the quantity remote controls that are manufactured unnecessarily (and later discarded);
It provides diagnostic information that renders the repair and maintenance of household appliances more effective/efficient and promotes user-oriented design.

Potential areas of application: the control of
Intelligent household appliances;
Entertainment electronics;
Games; and
Building automation equipment.

### LIST OF TERMS

1: External server

2: Controlled device

21 Controlled module

3A: Universal remote control device (used by the administrator)

3B: Universal remote control device (used by a user)

3A1, 3B1: Control module

3A2, 3B2: Analytical module

3A3, 3B3: Authentication module

4: External network

1. A process for operating electronic devices using a universal remote control and for collecting, utilising, and transmitting the operating parameters of such devices for the purposes of analysis, characterised in that the steps of this process are as follows:
the administrator downloads the application (I.) onto his/her mobile device from an external server; then he/she
registers on the external server and creates a personal profile (II.);
logs into the application (III.);
selects the devices he/she wishes to control from a list of controllable devices detected automatically by the application (IV.);
the application automatically downloads the user interfaces corresponding to the selected devices from the external server to the administrator's mobile device and in doing so, renders the selected devices remotely controllable from his/her mobile device, while at the same time, assigning the selected devices to the administrator's profile (V.);
the administrator uses the application to configure which of the items of information pertaining to the operation of the controlled devices will be sent to the analytical module for storage and analysis, as well as which items of information should be made accessible to third parties via the external network (VI.);
the administrator later uses his/her own profile to create subprofiles for other users that grant control privileges with regard to designated devices (VII.).

2. The process according to claim 1, characterised in that the mobile devices of other users become capable of accessing and controlling the appropriate subprofile once the application has been downloaded by the user and the user has been authenticated by the external server.

3. The process according to claim 1, characterised in that the administrator restricts access to the subprofiles in a manner that enables the unequivocal authentication of users, preferably via password.

4. The process according to claim 1, characterised in that the administrator has the ability to create subprofiles for other users with regard to individual controlled devices, each with restricted access rights.

5. The process according to claim 1, characterised in that the administrator has the ability to authorise administrator rights for other users equivalent to his/her own.

6. The process according to claim 1, characterised in that the administrator has the ability to order various user interfaces for each subprofile and each device.

7. The process according to claim 1, characterised in that the administrator has the ability to grant other users the authorisation to create custom user interfaces in their subprofiles for the devices they control and to use the application to download said interfaces to their mobile devices.

8. The process according to claim 1, characterised in that the administrator has the ability to define and/or restrict both the range of operating information collected and analysed by the analytical modules of the remote controls of other users, and has the ability to define and/or restrict what information is transmitted to third parties.

9. The process according to claim 1, characterised in that the re-registration of controllable devices already registered on the external server by an individual other than the administrator is not permitted.

10. A schematic for the operation of electronic devices by universal remote control that includes an external server (1) connected to an external network (4), at least one controlled device (2) containing a controlled module (21), at least one universal remote control device (3A) containing a control module (3A1) connected to the external network (4), characterised in that the universal remote control device (3A) has an authentication module (3A3) and an analytical module (3A2), which are connected bidirectionally to the external network (4), and that the control module (3A1) is connected bidirectionally to the controlled module (21) and unidirectionally to the analytical module (3A2).

11. The schematic according to claim 10, characterised in that the universal remote control device (3A) is any mobile device capable of, or that can be rendered capable of, performing the remote control function.

12. The schematic according to claim 10, characterised in that the mobile device is a smart phone and/or tablet.

13. The schematic according to claim 10, characterised in that the external network (4) is primarily the Internet.

14. The schematic according to claim 10, characterised in that the remote control devices of the administrator and other users (3A, 3B) form a physical unit.
